(19) United States
(12) Patent Application Publication
(10) Pub. No.: US 2011/0109425 A1
(43) Pub. Date: May 12, 2011

(54) IP Protection And Control Method Thereof

(75) Inventors: Chia-Chao KAN, Taipei (TW); Jie-Hong R. JIANG, Taipei (TW)

(73) Assignee: NATIONAL TAIWAN UNIVERSITY, Taipei (TW)

(21) Appl. No.: 12/818,856

(22) Filed: Jun. 18, 2010

(30) Foreign Application Priority Data
Nov. 10, 2009 (TW) 098138030

(51) Int. Cl. G06F 7/04

(52) U.S. Cl. 340/5.2

(57) ABSTRACT

An embodiment of the invention provides an integrated circuit with IP protection. The integrated circuit includes a hardware IP, an ID generator and a lock circuit. The ID generator generates an ID according to each manufactured hardware IP. The lock circuit locks the manufactured hardware IP and unlocks the manufactured hardware IP when receiving a key corresponding to the ID.

### CROSS REFERENCE TO RELATED APPLICATIONS

This Application claims priority of Taiwan Patent Application No. 098138030, filed on Nov. 10, 2009, the entirety of which is incorporated by reference herein.

### BACKGROUND OF THE INVENTION

1. Field of the Invention

The disclosure relates generally to a method for protecting intellectual property (IP) of an integrated circuit (IC).

2. Description of the Related Art

With continued technological advancements and investments by dedicated semiconductor foundries and high costs for advanced semiconductor foundry machinery, more and more integrated circuit design companies have decided to go fabless. Accordingly, with fabrication no longer in-house, situations where there is unauthorized use of intellectual property have grown. Typically, integrated circuit designers add extra encryption/decryption circuits or obfuscation logic circuits into their designs, so as to hinder unauthorized use of their intellectual property. Nevertheless, the added circuits increase fabrication costs, decreasing market competitiveness. Further, the added circuits may also require additional fabrication processes, which may decrease fabrication yields.

### BRIEF SUMMARY OF THE INVENTION

An embodiment of an intellectual property (IP) protection circuit for a hardware intellectual property includes an identification (ID) generator and a lock circuit. The identification generator generates an identification according to a manufactured hardware intellectual property. The lock circuit locks the manufactured hardware intellectual property and unlocks the manufactured hardware intellectual property when receiving a key corresponding to the identification.

Further, an embodiment of a control method for an intellectual property (IP) protection circuit includes the following steps. First, an identification is generated according to a manufactured hardware intellectual property. Next, the manufactured hardware intellectual property is transited to a first state through a lock circuit according to the identification. Afterwards, a key is received. The manufactured hardware intellectual property is then transited to a second state through the lock circuit according to the key. According to an embodiment, the manufactured hardware intellectual property is capable of being initialized for use when the second state is identical to an initial state of the manufactured hardware intellectual property, and is incapable of being initialized for use when the second state is different from the initial state of the manufactured hardware intellectual property.

A detailed description is given in the following embodiments with reference to the accompanying drawings.

### BRIEF DESCRIPTION OF THE DRAWINGS

The invention will become more fully understood by referring to the following detailed description with reference to the accompanying drawings, wherein:

FIG. 1 is a schematic diagram illustrating a process for protecting an integrated circuit (IC) according to the invention;

FIG. 2 is a diagram illustrating selection of a synchronizable element according to the invention;

FIG. 3 is a schematic diagram illustrating an integrated circuit (IC) with a protected intellectual property (IP) according to an embodiment of the invention;

FIG. 4 is a state transition table of a finite state machine of a 4-bit counter illustrating the relation between a key and an identification generator;

FIG. 5 illustrates a reset circuit for an integrated circuit (IC) with a protected intellectual property (IP) according to an embodiment of the invention;

FIG. 6 is a diagram illustrating the state transition of a finite state machine with three state variables; and

FIG. 7 illustrates an identification restrictor according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. Various embodiments are provided for implementing different features of the invention and are not intended to be limiting.

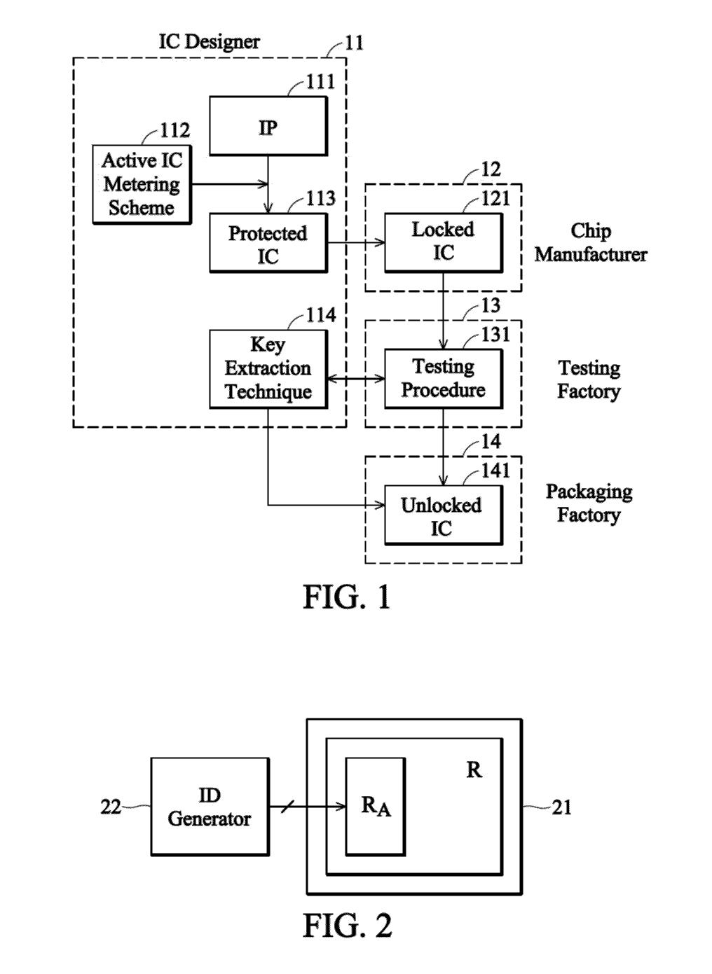

FIG. 1 is a schematic diagram illustrating a process for protecting an integrated circuit (IC) according to the invention. As shown in FIG. 1, a designed intellectual property (IP) 111 of an IC designer 11 may become a manufactured IC through a chip manufacturer 12, a testing factory 13, and a packaging factory 14. According to this embodiment, the IC designer 11 protects the IP 111 by use of an active IC metering scheme 112, so as to generate a protected IC 113. The operation of the active IC metering scheme 112 is similar to the encryption of the IP 111, but is fundamentally different from general software encryption. The active IC metering scheme 112 locks the IP 111 by use of a synchronizable element of the IP 111 to generate the protected IC 113. When the protected IC 113 is powered-on and the synchronizable element is in an incorrect state, rather than being reset to a specified initial state, the protected IC 113 is incapable of being activated. By this protection mechanism, the IC designer 11 provides the protected IC 113 to the chip manufacturer 12. Then, the chip manufacturer 12 is able to mass fabricate locked ICs 121. In this regard, the manufactured ICs, simply packaged from the dies diced from a wafer each implementing the locked IC 121, are still unable to be activated. As a result, the IP 111 of the IC designer 11 may be protected against unauthorized distribution from the chip manufacturer 12.

Referring to FIG. 1, a synchronizable circuit having the synchronizable element of the IP 111 is provided for locking and protecting the IP 111. It is desirable for the initial state of the synchronizable circuit to be a universally reachable state. That is, any state of the synchronizable circuit may be transited to the initial state by one or more state transitions. The universally reachable state of the synchronizable circuit may assure all IDs having their corresponding keys, thereby transiting the state of the IP 111 to the initial state. For example, a finite state machine may be provided for illustrating the synchronizable circuit. It is assumed that the finite state machine is a 4-bit counter having an input pin inc. If the input pin value inc is equal to 1, the counter is increased by 1. Otherwise, the count in the counter remains unchanged. The counter may count from [0000] in 15 steps to [1111] and from [1111] to [0000]. As such, all states of the finite state machine are universally reachable states. It is assumed that the initial state is set to [1001]. Thus, the state [1111] of the finite state machine may be transited to the initial state [1001] when a tenth state transition with the input pin value inc equal to 1 has been achieved.

In addition, a process variation due to manufacture controls of the chip manufacturer 12 may result in different locked ICs 121. An identification (ID) generator in the locked IC 121 may be utilized for generating a corresponding ID according to the process variation of the locked IC 121. The ID of the locked IC 121 may be readout by a testing procedure 131 of the testing factory 13, or be readout by the IC designer 11. The IC designer 11 may then generate a key according to the readout ID and a key extraction technique 114. The key is stored in a non-volatile memory, register, or pad ring. The packaging factory 14 subsequently packages the key and the locked IC 121 into an unlocked IC 141. When the unlocked IC 141 is powered-on, the inside synchronizable circuit first situates in a first state constrained by the ID. Then, the state of the synchronizable element is transited to the initial state according to the key, thus initializing the unlocked IC 141 for normal use.

The aforementioned description is provided for illustrating the IP protection of the invention and further description will be described below in detail. The above-mentioned synchronizable element may be a specified circuit originally designed within the IC, such as flip flops. The existing circuits may be used for performing encryption/decryption and protecting the IP. Additionally, since almost no extra circuits are required, the IP protection method costs small hardware area overhead and has small effects on the IC design flow.

Though the integrated circuit may be equipped with many synchronizable elements, not all of them are suitable for use in IP protection. Thus, selection of suitable synchronizable elements is a problem to be solved. Referring to FIG. 2, FIG. 2 is a diagram illustrating selection of a suitable set of synchronizable elements according to the invention. The element 21 represents an integrated circuit and a set R represents the set of all possible synchronizable elements, e.g., flip flops or registers, within the integrated circuit 21. Further, a subset R_{A} is selected from the set R. It is determined whether the initial state of the circuit associated with the subset R_{A} is a universally reachable state by testing under some conditions. If the test result indicates that the initial state is a universally reachable states, the subset R_{A} is reset by an ID generator 22. It is necessary for the circuit associated with the subset R_{A} to be set in the specified initial state through the key supplied from the IC designer after the circuit associated with the subset R_{A} is reset, such that the integrated circuit 21 can be normally operated.

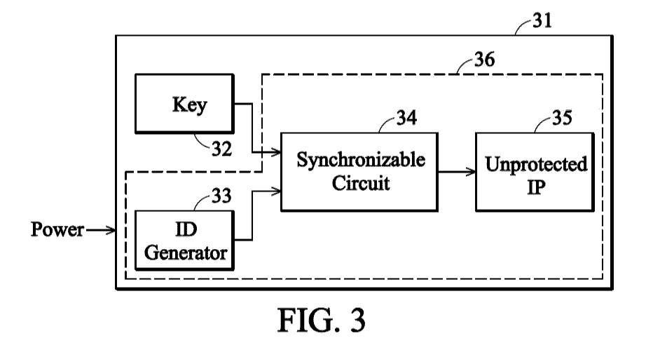

FIG. 3 is a schematic diagram illustrating an IC with a protected IP according to an embodiment of the invention. An integrated circuit 31 comprises a key 32 supplied from the IC designer, an ID generator 33, a synchronizable circuit 34 and an unprotected IP 35, wherein the ID generator 33, the synchronizable circuit 34 and the unprotected IP 35 form a protected IP 36. The ID generator 33 generates a unique ID according to a process variation due to manufacturing of the integrated circuit 31 and the unprotected IP 35 by the chip manufacturer. When the integrated circuit 31 receives power, the ID generator 33 first transmits the ID to the synchronizable circuit 34 to reset the synchronizable circuit 34 to a reset state. Following, the synchronizable circuit 34 initializes the unprotected IP 35 according to the key 32 and transits the state thereof to an initial state. The integrated circuit 31 may be activated for normal operation after initialization. In this embodiment, the key 32 may be stored in a non-volatile memory, such as a read-only memory (ROM). Specifically, the key 32 is stored in the non-volatile memory by the IC designer when the integrated circuit 31 is packaged. As such, the integrated circuit packaged from the unprotected IP 35 is still incapable of being activated for normal operation without the key 32 supplied from the IC designer, thus achieving IP protection.

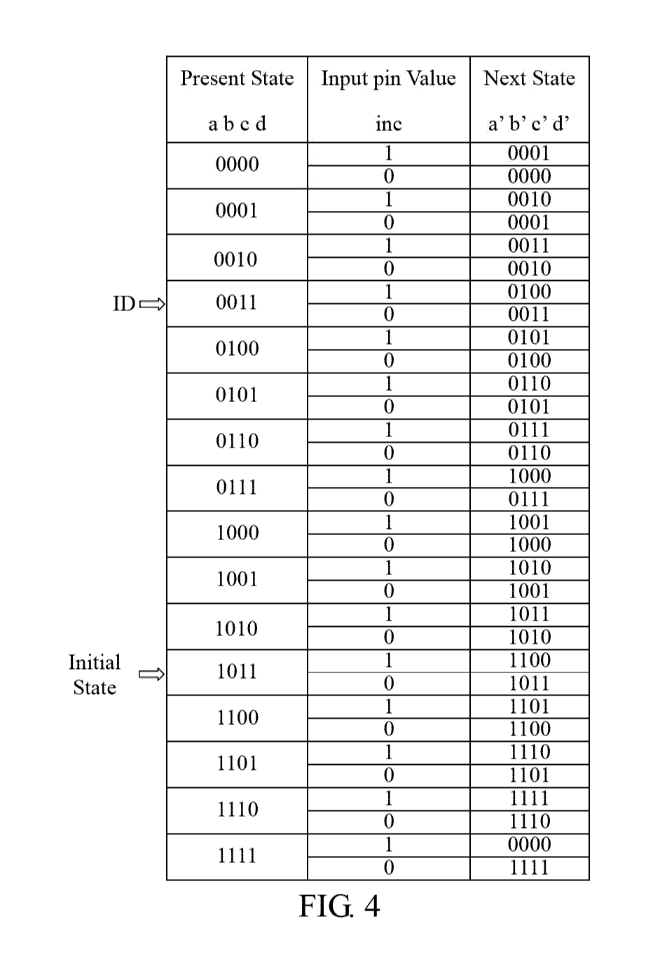

The synchronizable circuit with universally reachable states may be illustrated by a finite state machine according to the invention. FIG. 4 is a state transition table illustrating a finite state machine of a 4-bit counter for a key and an identification generator. The finite state machine of the 4-bit counter comprises 16 different states. It is assumed that the ID generated by the ID generator is also 4 bits. The ID generator first transmits the ID to the four state variables when the integrated circuit is powered-on. In this embodiment, it is assumed that the ID generated by the ID generator for some manufactured hardware IP is equal to [0011] and the initial state of the integrated circuit is equal to [1011]. The state of the finite state machine may not be transited to the initial state without the key, and the integrated circuit is incapable of being activated for normal operation until such condition is met. In this embodiment, the finite state machine is a sequential circuit and the state transition thereof is accordingly transited sequentially. Thus, the initial state of the finite state machine requires 8 state transitions with the input pin value inc equal to 1 in accordance with this embodiment. Further, the key of this embodiment is an input logic sequence of length 8, (1, 1, 1, 1, 1, 1, 1, 1). When the finite state machine receives the input pin value inc equal to 1, the present state of the finite state machine is then increased by 1 to be transited to a next state. When the finite state machine receives the input pin value inc equal to 0, the present state of the finite state machine remains unchanged. As a result, the state of the finite state machine may be transited to the initial state through the key sequence of length 8, i.e., (1, 1, 1, 1, 1, 1, 1, 1). Moreover, the initialization of the protected IP in the integrated circuit may activate the integrated circuit for normal operation.

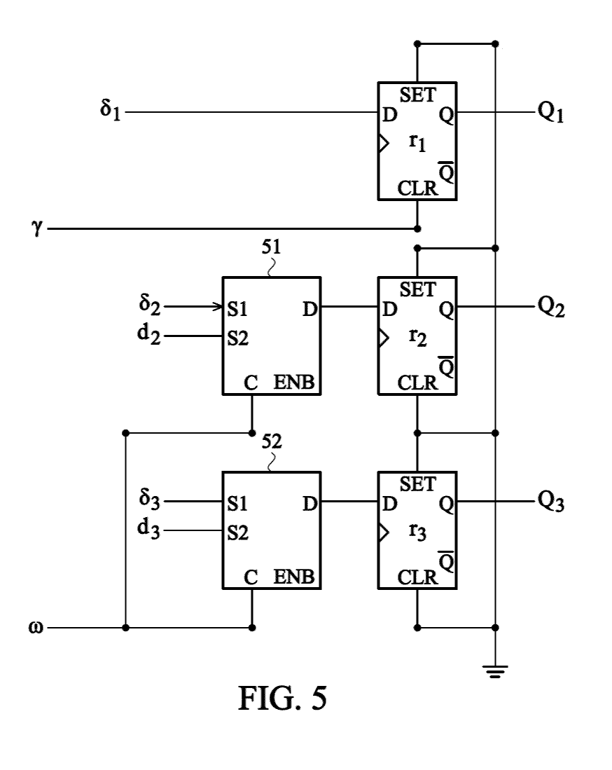

FIG. 5 illustrates a reset circuit according to an embodiment of the invention. The reset circuit sets a reset state according to the ID of a chip or a protected IP. In this embodiment, the reset operation is done by setting signals γ and ω to 1. When the reset circuit receives a key, the signal ω is set to 0. Next, the protected IP is initialized. The outputs Q₁, Q₂ and Q₃ of registers r₁, r₂ and r₃ may correspond to the initial state of the protected IP after initialization. The reset circuit comprises multiplexers 51, 52 and the registers r₁, r₂ and r₃. As shown in FIG. 5, the signal γ is used for control of clearing data stored in the register r₁ and the signal ω is used for controlling the signal output from the multiplexers 51 and 52. When the signal ω is equal to 1, the multiplexers 51 and 52 output the ID values d₂ and d₃ from the ID generator. When the signal ω is equal to 0, the multiplexers 51 and 52 respectively output results obtained from state transition functions δ₂ and δ₃ to the registers r₂ and r₃. When the signal γ is set to 1, the registers r₁ is reset to 0. When the signal γ is set to 0, the registers r₁ outputs a result Q₁ obtained from a state transition function δ₁.

According to an embodiment, the state transition functions δ₁, δ₂ and δ₃ may be represented as follows:

δ₁=s₁·(s₂+s₃),

δ₂=(s₂⊕s₃), and

δ₃=s₂+s₁′·s₃′,

wherein “⊕” denotes an XOR operation, “·” denotes an AND operation, “+” denotes an OR operation, “′” denotes a NOT operation, s₁ represents the state variable of the register r₁, s₂ represents the state variable of the register r₂, and s₃ represents the state variable of the register r₃.

TABLE 1

| present state | | | next state | | |
|---|---|---|---|---|---|
| s₁ | s₂ | s₃ | s₁ | s₂ | s₃ |
| 0 | 0 | 0 | 0 | 0 | 1 |
| 0 | 0 | 1 | 0 | 1 | 0 |
| 0 | 1 | 0 | 0 | 1 | 1 |
| 0 | 1 | 1 | 0 | 0 | 1 |
| 1 | 0 | 0 | 0 | 0 | 0 |
| 1 | 0 | 1 | 0 | 1 | 0 |
| 1 | 1 | 0 | 0 | 1 | 1 |
| 1 | 1 | 1 | 0 | 0 | 1 |

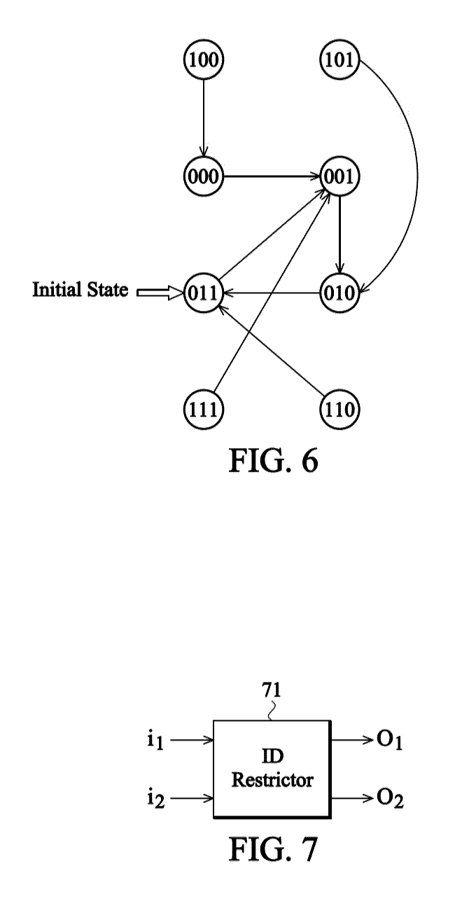

According to the circuit in FIG. 5, it is assumed that the ID values d₂ and d₃ output from the ID generator can be 00, 01, 10 and 11. As such, after the signal γ and ω are set to 1, i.e., the registers r₁, r₂ and r₃ are reset, the possible states becomes 000, 001, 010 and 011. Next, when the signal γ is set to 1 and the signal ω is set to 0, the corresponding state variable of the registers r₁ is equal to a constant 0. That is, the state transition function δ₁ is replaced by a zero function and the state transition functions δ₂ and δ₃ corresponding to the registers r₂ and r₃ are unchanged. For the new state transition, reference may be made to Table 1. For the finite state machine with state variables s₁, s₂ and s₃, reference may be made to FIG. 6 for its state transition diagram. Assuming that the initial state is equal to 011, at least one input logic sequence (key) exists for transiting each reset state 000, 001, 010 or 011 to the initial state. For example, the reset state 000 may be transited to the initial state 011 after the third, sixth, ninth . . . clocks. The reset state 001 may be transited to the initial state 011 after the second, fifth, eighth . . . clocks. The reset state 010 may be transited to the initial state 011 after the first, fourth, seventh . . . clocks. The reset state 011 may be transited to the initial state 011 after the zeroth, third, sixth, ninth . . . clocks. In this particular embodiment, it is noted that the sequence length of the key determines whether the initial state is able to be transited, rather than the sequence value of the key.

From the aforementioned description of each hardware ID, a problem due to no existing key for some IDs may occur. In this regard, an ID restrictor 71 is provided for solving the problem due to the absence of a valid key for some ID value. FIG. 7 illustrates an ID restrictor 71 according to an embodiment of the invention. The ID restrictor 71 receives an initial ID (i₁, i₂) and generates another ID (O₁, O₂). Referring to Table 2, Table 2 is a truth table of the ID restrictor 71.

TABLE 2

| i₁ | i₂ | O₁ | O₂ |
|---|---|---|---|
| 0 | 0 | 0 | 1 |
| 0 | 1 | 1 | 0 |
| 1 | 0 | 1 | 0 |
| 1 | 1 | 1 | 1 |

The function associated with the output O₁ and O₂ are represented as follows:

O₁=i₁+i₂, and

O₂=i₁·i₂+i₁′·i₂′.

According to the truth table of the ID restrictor 71, the possible outputs (O₁, O₂) are (0, 1), (1, 0) or (1, 1).

For the operation of the ID restrictor 71, reference may be made to FIG. 6. It is assumed that the state transition from the state (s₁, s₂, s₃)=(0, 0, 0) to the state (s₁, s₂, s₃)=(0, 0, 1) is changed to the state transition from the state (s₁, s₂, s₃)=(0, 0, 0) to itself. In this case, there is no key that can transit the state 000 to the initial state 011. To ensure that the circuit can be correctly initialized by excluding the reset state 000, the register r₁ can be reset to 0 as before, the register r₂ is reset to the value of O₁, and the register r₃ is reset to the value of O₂. Thus, the output O₁ and O₂ of the ID restrictor 71 results in the reset state to be equal to 001, 010 or 011, and at least one input logic sequence exists for transiting each reset state to the initial state 011.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An intellectual property (IP) protection circuit for a hardware intellectual property, comprising:
an identification (ID) generator for generating an identification according to a manufactured hardware intellectual property; and
a lock circuit for locking the manufactured hardware intellectual property and unlocking the manufactured hardware intellectual property when receiving a key corresponding to the identification.

2. The intellectual property protection circuit as claimed in claim 1, wherein the lock circuit performs the unlocking procedure by transiting the state of the manufactured hardware intellectual property to an initial state.

3. The intellectual property protection circuit as claimed in claim 2, wherein the lock circuit transits the state of the manufactured hardware intellectual properly to an error state which is incapable of activating the manufactured hardware intellectual property when receiving an incorrect key.

4. The intellectual property protection circuit as claimed in claim 2, wherein the lock circuit is a reset circuit for transiting the state of the manufactured hardware intellectual property to the initial state when the key is received.

5. The intellectual property protection circuit as claimed in claim 1, wherein the identification is generated according to a process variation when manufacturing the manufactured hardware intellectual property.

6. The intellectual property protection circuit as claimed in claim 2, wherein the manufactured hardware intellectual property comprises a plurality of registers and the identification is loaded into at least one register of the registers when the manufactured hardware intellectual property receives a trigger signal.

7. The intellectual property protection circuit as claimed in claim 6, wherein the lock circuit transits the state of each register to the initial state according to the key after the identification is loaded into the registers.

8. The intellectual property protection circuit as claimed in claim 6, wherein the manufactured hardware intellectual property further comprises a plurality of pins coupled to the identification generator for receiving the identification from the pins and storing the identification to the registers.

9. The intellectual property protection circuit as claimed in claim 1, further comprising:
an identification restrictor for generating the identification based on an initial identification which is generated according to a process variation when manufacturing the manufactured hardware intellectual property.

10. The intellectual property protection circuit as claimed in claim 1, further comprising:
an encryption unit for encrypting the initial identification, which is generated according to a process variation when manufacturing the manufactured hardware intellectual property, and generating the identification.

11. The intellectual property protection circuit as claimed in claim 10, wherein the encryption unit is a key encryption unit for encrypting the initial identification through a public key and generating the identification.

12. The intellectual property protection circuit as claimed in claim 11, wherein the identification is decrypted to the initial identification through a private key.

13. A control method for an intellectual property (IP) protection circuit, comprising:
generating an identification according to a manufactured hardware intellectual property;
transiting the manufactured hardware intellectual property to a first state through a lock circuit according to the identification;
receiving a key; and
transiting the manufactured hardware intellectual property to a second state through the lock circuit according to the key,
wherein the manufactured hardware intellectual property is capable of being initialized for use when the second state is identical to an initial state of the manufactured hardware intellectual property, and is incapable of being initialized for use when the second state is different from the initial state of the manufactured hardware intellectual property.

14. The control method as claimed in claim 13, wherein the identification is generated according to a process variation when manufacturing the manufactured hardware intellectual property.

15. The control method as claimed in claim 13, wherein the lock circuit is a reset circuit.

16. The control method as claimed in claim 13, wherein the manufactured hardware intellectual property comprises a plurality of registers and the identification is loaded into the registers when the manufactured hardware intellectual property receives a trigger signal.

17. The control method as claimed in claim 16, wherein the lock circuit transits the state of each register to the second state according to the key after the identification is loaded into the registers.

18. The control method as claimed in claim 13, wherein the step of generating the identification according to the manufactured hardware intellectual property comprises:
generating an initial identification according to a process variation when manufacturing the manufactured hardware intellectual property; and
generating the identification by encrypting the initial identification through an encryption unit.

19. The control method as claimed in claim 18, wherein the encryption unit is substituted for an irreversible programmable unit.

20. The control method as claimed in claim 18, wherein the encryption unit is a key encryption unit for encrypting the initial identification through a public key and generating the identification.

21. The control method as claimed in claim 18, wherein the identification is decrypted to the initial identification through a private key.
